(19) United States
(12) Patent Application Publication
(10) Pub. No.: US 2026/0065322 A1
(43) Pub. Date: Mar. 5, 2026

(54) SYSTEMS AND METHODS FOR GEOFENCE-BASED TRANSACTION COMMUNICATIONS

(71) Applicant: Wells Fargo Bank, N.A., San Francisco, CA (US)

(72) Inventors: Cecil B. Burrowes, San Francisco, CA (US); Michelle L. Mercado, San Francisco, CA (US); Franco Ramos-Johnson, Orlando, FL (US); Adam E. Vancini, Concord, CA (US)

(73) Assignee: Wells Fargo Bank, N.A., San Francisco, CA (US)

(21) Appl. No.: 18/826,040

(22) Filed: Sep. 5, 2024

(51) Int. Cl. G06Q 30/0251; G06Q 20/32

(52) U.S. Cl. CPC G06Q 30/0261; G06Q 20/3224; G06Q 30/0267

(57) ABSTRACT

Systems and methods are described herein for transmitting offers based on a geofence via a transfer service computing system. Such systems and methods may use a transfer service computing system to receive, an offer relating to a merchant and corresponding to a geographical area associated with the merchant, identify a geofence including the geographical area, receive a location of the user device and determine that the location of the user device is within the geofence. The transfer service computing system may transmit, to the user device, the offer based on the determination that the location of the user device is within the geofence. The transfer service computing system may transmit a transaction request to the provider computing system or to a third-party computing system based on receiving an acceptance of the offer from the user device.

### TECHNICAL FIELD

The present disclosure relates to systems and methods for transmitting transaction communications. More specifically, the present disclosure relates to identifying recipients based on a geofence and transmitting a transaction communication to the recipients based on the geofence.

### BACKGROUND

Merchants may wish to promote their business or specific products or services to recipients within a particular locale but have difficultly identifying recipients that are likely to become customers based on geographic constraints.

### SUMMARY

An embodiment relates to a transfer service computing system. The transfer service computing system includes a processing circuit having a processor coupled to a memory device. The memory device stores instructions thereon that, when executed by the processor, cause the processing circuit to perform operations including: receiving, from a provider computing system or from a user interface displayed on a user device of a recipient via the transfer service computing system, an offer relating to a merchant and corresponding to a geographical area associated with the merchant; identifying a geofence including the geographical area; receiving a location of the user device; determining that the location of the user device is within the geofence; transmitting, to the user device, the offer based on the determination that the location of the user device is within the geofence; and transmitting a transaction request to the provider computing system or to a third-party computing system based on receiving an acceptance of the offer from the user device.

Another embodiment relates to a method. The method includes: receiving, by a transfer service computing system and from a provider computing system or from a user interface displayed on a user device of a recipient via the transfer service computing system, an offer relating to a merchant and corresponding to a geographical area associated with the merchant; identifying, by the transfer service computing system, a geofence including the geographical area; receiving, by the transfer service computing system, a location of the user device; determining, by the transfer service computing system, that the location of the user device is within the geofence; transmitting, by the transfer service computing system and to the user device, the offer based on the determination that the location of the user device is within the geofence; and transmitting a transaction request to the provider computing system or to a third-party computing system based on receiving an acceptance of the offer from the user device.

Another embodiment relates to a non-transitory computer-readable medium storing instructions that, when executed by a processor of a processing circuit, cause the processing circuit to receive, from a provider computing system or from a user interface displayed on a user device of a recipient via a transfer service computing system, an offer relating to a merchant and corresponding to a geographical area associated with the merchant; identify a geofence including the geographical area; receive a location of the user device; determine that the location of the user device is within the geofence; transmit, to the user device, the offer based on the determination that the location of the user device is within the geofence; and transmit a transaction request to the provider computing system or to a third-party computing system based on receiving an acceptance of the offer from the user device.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 depicts a block diagram of a system for transmitting geofence-based transaction communications, according to an example embodiment.

FIG. 2 depicts a method for transmitting a geofence-based transaction communication, according to an example embodiment.

FIG. 3 depicts a method for generating a geofence-based transaction communication, according to an example embodiment.

FIG. 4 depicts a method for receiving a geofence-based transaction communication, according to an example embodiment.

FIG. 5 depicts a graphical user interface (GUI) for transmitting a geofence-based transaction communication, according to an exemplary embodiment.

FIG. 6 depicts a GUI for viewing analytics relating to a history of geofence-based transaction communications, according to an exemplary embodiment.

FIG. 7 depicts a GUI for receiving a geofence-based transaction communication, according to an example embodiment.

### DETAILED DESCRIPTION

Referring generally to the figures, systems and methods for transmitting geofence-based transaction communications are disclosed. The systems and methods disclosed herein use location information from a plurality of recipients to identify recipients within the geofence. The identified recipients within the geofence may then receive geofence-based transaction communications from a merchant that correspond to the geofence.

As described herein, a real time or nearly real-time transfer service computing system environment includes a transfer service computing system configured to route transfer requests between sender and recipient devices based on one or more registered identifier(s) via a network. Each of the sender and recipient devices are associated with a corresponding sender/recipient computing system that is owned, controlled, managed, and/or operated by a corresponding provider institution (e.g., a financial institution). Each sender/recipient computing system is configured to store account information related to a plurality of customer accounts (e.g., accounts of senders and/or recipients). For example, the account information may include location information and transaction histories.

Beneficially, because the transfer service computing system may be configured to facilitate communication between a multitude of sender and recipients devices and may be configured to access the account information related to a plurality of accounts, the transfer service computing system may use the account information (e.g., location information) to communicate offers (e.g., from merchants) of interest to various users (e.g., recipients) based on the account information. Therefore, the implementations described herein may allow merchants with a customer account accessible by the transfer service computing system with an efficient and cost-effective way of promoting/advertising their products/services to customers (e.g., recipients), or enabling transactions to be made in association with such a promotion or advertisement in the form of a geofence-based transaction communication. The implementations described herein may prove particularly beneficial to merchants with limited funds/resources to spend on advertising (e.g., small businesses).

The implementations described herein address a technical problem by providing enhanced data integration and analysis capabilities, which deliver a particular technical solution that streamlines and refines generation and transmittal of location-specific offers based on a geofence. The systems and methods described herein are implemented to improve how data is synthesized and utilized from various sources that provide information relating to offers from a merchant and information relating to a recipient's location. By integrating data related to a recipient's location, these systems and methods provide proactive transmittal of offers to recipients within a location corresponding to a location of an offer from a merchant. For example, the implementations can provide an offer to a recipient based on the location of the recipient being aligned with a merchant's location. In another example, the implementations can provide an actionable communication that enables the recipient to transact, for example, via their mobile device (e.g., make a purchase on their mobile device in relation to a geofence-based transaction communication, such as a promotion or offer). Accordingly, this approach provides a specific technical improvement to various technical problems, including those set forth herein.

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

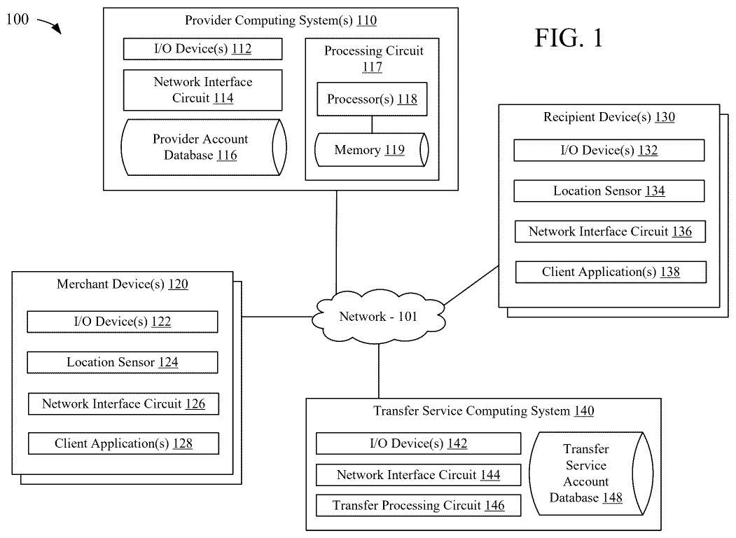

FIG. 1 is a diagram of a computing environment 100 for transmitting geofence-based transaction communications, according to an example embodiment. As described herein, a geofence-based transaction communication may take the form of an offer, such as a discount or other benefit (e.g., enrollment in a subscription service, a complimentary good/service, an amount of rewards points, etc.) related to a good/service provided by a merchant. As shown, the computing environment 100 includes one or more provider computing systems 110, one or more merchant devices 120, one or more recipient devices 130, and a transfer service computing system 140. The provider computing systems 110, the merchant devices 120, the recipient devices 130, and the transfer service computing system 140 are in communication with each other and are connected by a network 101.

The network 101 can include any type or form of one or more networks. The geographical scope of the network 101 can vary widely and the network 101 can include a body area network (BAN), a personal area network (PAN), a local-area network (LAN), e.g., Intranet, a metropolitan area network (MAN), a wide area network (WAN), or the Internet. The topology of the network 101 can be of any form and can include, e.g., any of the following: point-to-point, bus, star, ring, mesh, or tree. The network 101 can include an overlay network which is virtual and sits on top of one or more layers of other networks. The network 101 can be of any such network topology as known to those ordinarily skilled in the art capable of supporting the operations described herein. The network 101 can utilize different techniques and layers or stacks of protocols, including, e.g., the Ethernet protocol, the Internet protocol suite (TCP/IP), the Asynchronous Transfer Mode technique, the SONET (Synchronous Optical Networking) protocol, or the SD (Synchronous Digital Hierarchy) protocol. The TCP/IP Internet protocol suite can include application layer, transport layer, Internet layer (including, e.g., IPv6), or the link layer. The network 101 can include a type of a broadcast network, a telecommunications network, a data communication network, or a computer network.

For clarity, the following description will refer to a provider computing system 110, a merchant device 120, a recipient device 130, and a transfer service computing system 140. However, it will be understood that, in some instances, the computing environment 100 may include multiple provider computing systems similar to the provider computing system 110, multiple merchant devices similar to the merchant device 120, multiple recipient devices similar to the recipient device 130, and/or multiple transfer service computing systems similar to the transfer service computing system 140.

The provider computing system 110 is owned by, associated with, or otherwise operated by a provider institution (e.g., a bank or other financial institution) that maintains one or more accounts held by various customers (e.g., a merchant associated with the merchant device 120, a recipient associated with the recipient device 130), such as demand deposit accounts, credit card accounts, receivables accounts, and so on. In some instances, the provider computing system 110 may be embodied by one or more servers, each with one or more processing circuits (e.g., processing circuit 117) having one or more processors (e.g., processor(s) 118) configured to execute instructions stored in one or more memory devices (e.g., memory 119) to send and receive data stored in the one or more memory devices and perform other operations to implement the methods described herein associated with logic or processes shown in the figures. In some instances, the provider computing system 110 may include and/or have various other devices communicably coupled thereto, such as, for example, desktop or laptop computers (e.g., tablet computers), smartphones, wearable devices (e.g., smartwatches), and/or other suitable devices.

In some embodiments, the provider computing system 110 includes one or more I/O devices 112, a network interface circuit 114, and a provider account database 116. The one or more I/O devices 112 are configured to receive inputs from and display information to a user. While the term “I/O” is used, it should be understood that the I/O devices 112 may be input-only devices, output-only devices, and/or a combination of input and output devices.

In some instances, the network interface circuit 114 includes, for example, program logic that connects the provider computing system 110 to the network 101. For example, in some instances, the program logic interfaces with one or more transceivers (e.g., Bluetooth, Wi-Fi, or any other suitable communication transceivers) to enable connection with the network 101. The network interface circuit 114 facilitates secure communications between the provider computing system 110, the merchant device 120, the recipient device 130, and the transfer service computing system 140. The network interface circuit 114 also facilitates communication with other entities, such as other banks or financial institutions, settlement systems, and so on. The network interface circuit 114 further includes user interface program logic configured to generate and present web pages to users accessing the provider computing system 110 over the network 101.

The provider account database 116 is structured or configured to retrievably store customer account information associated with various customer accounts held or otherwise maintained by the provider institution on behalf of its customers. In some instances, the customer account information includes both customer information and account information pertaining to a given customer account. For example, in some instances, the customer information may include a name, a phone number, an e-mail address, a physical address, an occupation, etc. of the customer associated with the customer account. In some instances, the account information may include transaction information, information pertaining to the type and corresponding capabilities of the given account, a transfer service token (e.g., a phone number, an e-mail address, or a tag associated with a particular transfer service account) associated with the customer account, etc. of the customer account. In some embodiments, a merchant associated with the merchant device 120, as described herein, may be a customer of the provider institution and may have account information stored in the provider account database 116. Alternatively or additionally, a recipient associated with the recipient device 130, as described herein, may be a customer of the provider institution and may have account information stored in the provider account database 116.

In some embodiments, the provider account database 116 may also be configured to store transactions associated with the various customer accounts held or otherwise maintained by the provider institution on behalf of its customers. In some embodiments, the stored transactions may include a transaction history of past transactions. Alternatively or additionally, the provider account database 116 may store upcoming transactions that are scheduled to occur in the future. For example, the provider account database 116 may receive the upcoming transactions from client application 128/138, as described below, as an input from the merchant device 120/recipient device 130, respectively. The provider account database 116 may be configured to store, with each of the transactions, transaction data associated with each transaction. For example, the transaction data may include a transaction amount, a transaction method, a date of completion, one or more parties, a purpose code, and so on, associated with each stored transaction.

The provider computing system 110 is shown to include the processing circuit 117, including processor(s) 118 and memory 119. The processing circuit 117 may be structured or configured to execute or implement the instructions, commands, and/or control processes described herein with respect to the processor(s) 118 and memory 119.

The processing circuit 117 is shown to include processor(s) 118. The processor(s) 118 may be implemented or performed with a general-purpose single-or multi-chip processor, a digital signal processor (DSP), an application specific integrated circuit (ASIC), one or more field programmable gate arrays (FPGAs), or other suitable electronic processing components. A general-purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some embodiments, the processors 118 may be shared by multiple circuits (e.g., the circuits of the processor(s) 118 may include or otherwise share the same processor which, in some example embodiments, may execute instructions stored, or otherwise accessed, via different areas of the memory 119). Alternatively or additionally, the processor(s) 118 may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The processing circuit 117 is also shown to include memory 119. The memory 119 (e.g., memory, memory unit, storage device, etc.) may include one or more devices (e.g., RAM, ROM, Flash memory, hard disk storage, etc.) for storing data and/or computer code for completing or facilitating the processes, layers, and modules described in the present application. The memory 119 may be or include tangible, non-transient volatile memory or non-volatile memory. The memory 119 may also include database components, object code components, script components, or any other type of information structure for supporting the activities and information structures described in the present application.

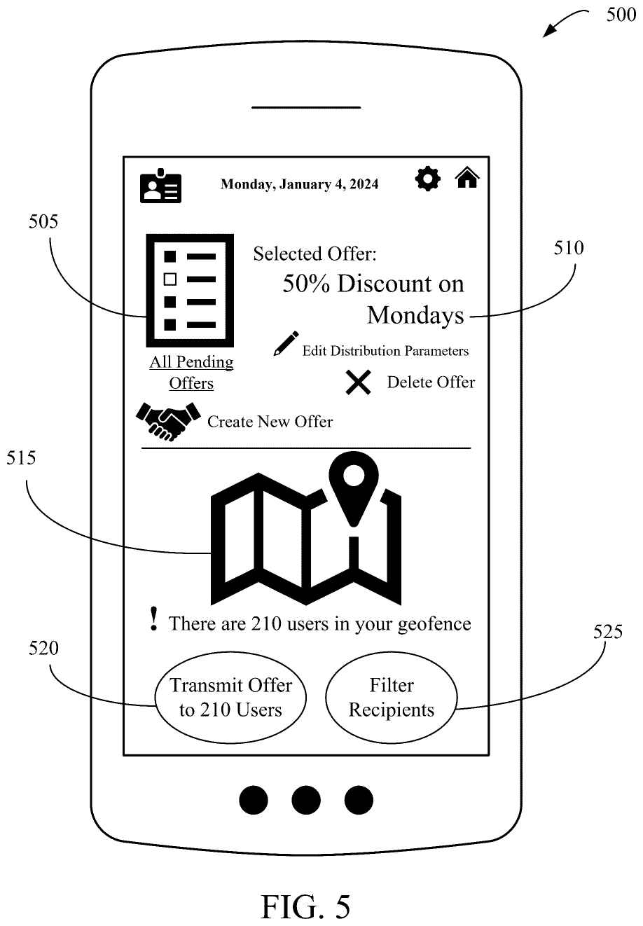

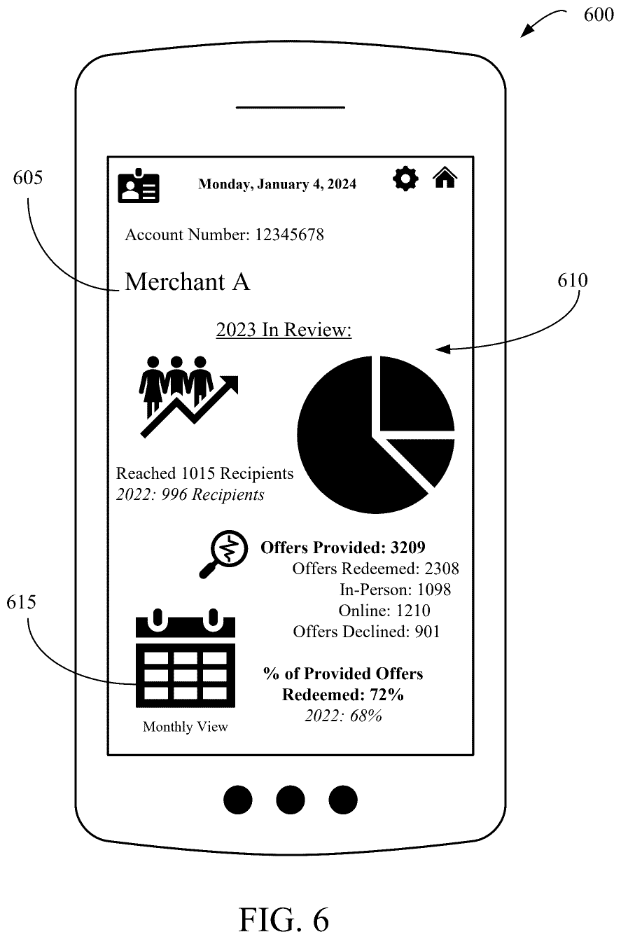

The merchant device 120 is owned, operated, controlled, managed, and/or otherwise associated with a user, namely a merchant. The merchant refers to an entity that sells or otherwise provides goods and/or services to consumers. In some embodiments, the merchant may be a customer of the provider institution associated with the provider computing system 110. The merchant device 120 may be or may include, for example, a desktop or laptop computer, a smartphone, a tablet computer, a wearable device (e.g., a smartwatch), a personal digital assistant, and/or any other suitable computing device. In the example shown in FIGS. 5-6, the merchant device 120 is structured as a mobile computing device, namely a smartphone.

In some embodiments, the merchant device 120 includes one or more I/O devices 122, a location sensor 124, a network interface circuit 126, and one or more client applications 128. While the term “I/O” is used, it should be understood that the I/O devices 122 may be input-only devices, output-only devices, and/or a combination of input and output devices. In some instances, the I/O devices 122 include various devices that provide perceptible outputs (such as display devices with display screens and/or light sources for visually-perceptible elements, an audio speaker for audible elements, and haptics or vibration devices for perceptible signaling via touch, etc.), that capture ambient sights and sounds (such as digital cameras, microphones, etc.), and/or that allow the user (e.g., the merchant) to provide inputs (such as a touchscreen display, stylus, keyboard, force sensor for sensing pressure on a display screen, etc.). In some instances, the I/O devices 122 further include one or more user interfaces (devices or components that interface with the user), which may include one or more biometric sensors (such as a fingerprint reader, a heart monitor that detects cardiovascular signals, face scanner, an iris scanner, etc.). The location sensor 124 may be a GPS device used to determine a location of the merchant device 120.

The network interface circuit 126 includes, for example, program logic and various devices (e.g., transceivers, etc.) that connect the merchant device 120 to the network 101. The network interface circuit 126 facilitates secure communications between the merchant device 120 and each of the provider computing system 110, the recipient device 130, and the transfer service computing system 140. The network interface circuit 126 also facilitates communication with other entities, such as other banks, settlement systems, and so on.

The merchant device 120 stores in computer memory, and executes (“runs”) using one or more processors, various client applications 128 configured to enable various functionalities. In some instances, the client applications 128 include various Internet browser applications presenting websites and/or applications provided other entities.

In some embodiments, the client applications 128 may include a provider client application. In some instances, the provider client application may be a financial institution banking application provided by and at least partly supported by the provider computing system 110. In some instances, the provider client application is coupled to the provider computing system 110 and may enable account management regarding one or more accounts held at the provider institution associated with the provider computing system 110 (e.g., funds transfers, bill payment, etc.). In some instances, the provider client application provided by the provider computing system 110 incorporates various functionality provided by or otherwise enabled by the transfer service computing system 140 (e.g., initiating and/or approving transfers) using one or more application programming interfaces (APIs) and/or software development kits (SDKs) provided by the transfer service computing system 140.

In some instances, the client applications 128 further include a transfer service client application provided by and at least partly supported by the transfer service computing system 140. In some instances, the transfer service client application is coupled to the transfer service computing system 140 and may enable the merchant to initiate and/or approve various transactions enabled by a transfer service associated with the transfer service computing system 140, as described below.

Accordingly, the provider client application and the transfer service client application are structured to provide the merchant with access to various services offered by the provider institution and the transfer service, respectively. In some embodiments, the provider client application and/or the transfer service client application are hard coded onto the memory of the merchant device 120. In some embodiments, the provider client application and/or the transfer service client application are web-based interface applications, where the merchant has to log onto or access the web-based interface before usage, and these applications are supported by a separate computing system including one or more servers, processors, network interface circuits, or the like (e.g., the provider computing system 110, the transfer service computing system 140), that transmit the applications for use to the merchant device 120.

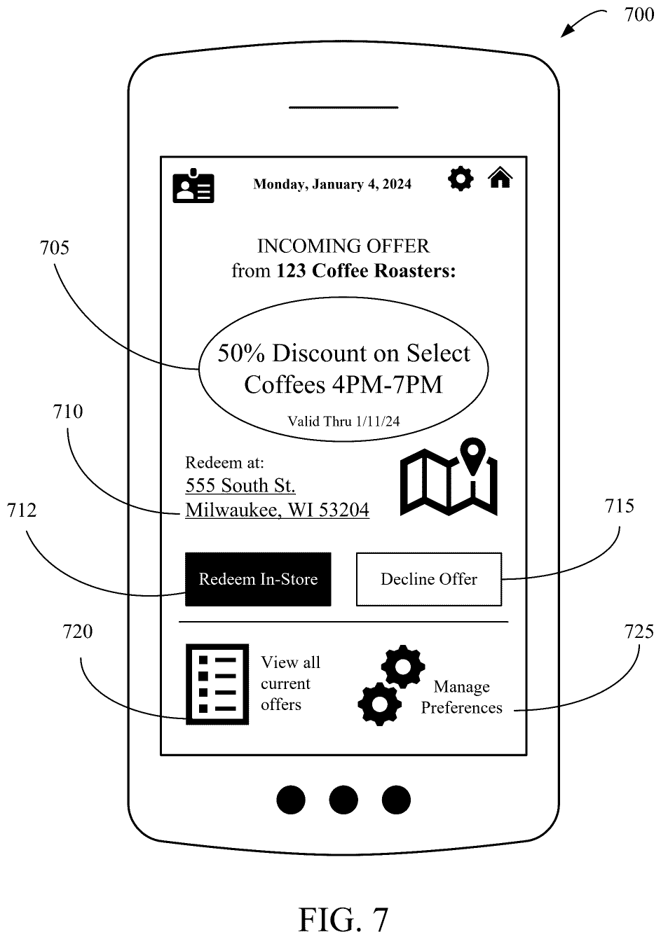

The recipient device 130 is owned, operated, controlled, managed, and/or otherwise associated with a user, namely a recipient. The recipient refers to a consumer who has opted-in to receiving location-based offers from a merchant (e.g., the merchant associated with the merchant device 120). In some embodiments, the recipient device 130 may be or may include, for example, a desktop or laptop computer, a smartphone, a tablet computer, a wearable device (e.g., a smartwatch), a personal digital assistant, and/or any other suitable computing device. In the example shown in FIG. 7, the recipient device 130 is structured as a mobile computing device, namely a smartphone.

In some embodiments, the recipient device 130 includes one or more I/O devices 132, a location sensor 134, a network interface circuit 136, and one or more client applications 138. While the term “I/O” is used, it should be understood that the I/O devices 132 may be input-only devices, output-only devices, and/or a combination of input and output devices. In some instances, the I/O devices 132 include various devices that provide perceptible outputs (such as display devices with display screens and/or light sources for visually-perceptible elements, an audio speaker for audible elements, and haptics or vibration devices for perceptible signaling via touch, etc.), that capture ambient sights and sounds (such as digital cameras, microphones, etc.), and/or that allow the user (e.g., the recipient) to provide inputs (such as a touchscreen display, stylus, keyboard, force sensor for sensing pressure on a display screen, etc.). In some instances, the I/O devices 132 further include one or more user interfaces (devices or components that interface with the user), which may include one or more biometric sensors (such as a fingerprint reader, a heart monitor that detects cardiovascular signals, face scanner, an iris scanner, etc.). The location sensor 134 may be a GPS device used to determine a location of the recipient device 130.

The network interface circuit 136 includes, for example, program logic and various devices (e.g., transceivers, etc.) that connect the recipient device 130 to the network 101. The network interface circuit 136 facilitates secure communications between the recipient device 130 and each of the provider computing system 110, the merchant device 120, and the transfer service computing system 140. The network interface circuit 136 also facilitates communication with other entities, such as other banks, settlement systems, and so on.

The recipient device 130 stores in computer memory, and executes (“runs”) using one or more processors, various client applications 138 configured to enable various functionalities. In some instances, the client applications 138 include various Internet browser applications presenting websites and/or applications provided other entities. In some embodiments, the client applications 138 may include the provider client application and/or the transfer service client application, as described above with reference to the merchant device 120.

Accordingly, the provider client application and the transfer service client application are structured to provide the recipient with access to various services offered by the provider institution and the transfer service, respectively. In some embodiments, the provider client application and/or the transfer service client application are hard coded onto the memory of the recipient device 130. In some embodiments, the provider client application and/or the transfer service client application are web-based interface applications, where the recipient has to log onto or access the web-based interface before usage, and these applications are supported by a separate computing system including one or more servers, processors, network interface circuits, or the like (e.g., the provider computing system 110, the transfer service computing system 140), that transmit the applications for use to the recipient device 130.

The transfer service computing system 140 is controlled by, managed by, owned by, and/or otherwise associated with a transfer service entity (e.g., Zelle®, RTP®, FedNow®) that is configured to enable real-time or nearly real-time transfers. As described herein and in one embodiment, the “transfer” is a payment or fund/resource transfer. However, the present disclosure is also applicable with other types of transfers, such as the secure transfer of information (e.g., documents). The payment or fund transfer may include electronic or digital fund transfers. As described herein, the transfer service computing system 140 may also transmit offers from a merchant to a recipient. In some embodiments, redeeming the offer may include performing a fund/resource transfer via the transfer service computing system 140.

In some instances, the transfer service entity may be a financial institution (e.g., a card network) or other entity that supports transfers across multiple different entities (e.g., across different financial institutions). In some instances, the transfer service entity may, for example, be an entity that is formed as a joint venture between banks and/or other entities that send and receive funds using the computing environment 100. As another example, the transfer service entity may be a third-party vendor. As still another example, the transfer service entity may be provided by one of the provider institutions, such that the provider institution performs both the operations described herein as being performed by the provider computing systems 110 and the operations described herein as being performed by the transfer service computing system 140.

The transfer service computing system 140 is configured, in various embodiments, to provide (e.g., through its own client application or through integration with a client application of another entity, such as the provider client application) at least some of the functionality depicted in the figures and described herein (e.g., transmitting offers between a merchant and a recipient based on location information, enabling transfers between accounts held by the merchant and accounts held by the recipients). For example, in some instances, the transfer service entity provides or hosts a web portal provided for an online community of individuals where such individuals obtain usernames/login IDs or otherwise become registered members to enable real-time or nearly real-time transfers.

In some instances, as discussed above, at least some of the functionality performed by the transfer service computing system 140 is integrated within various banking applications (e.g., the provider client application) provided by the provider computing system 110 to the merchant device 120 and/or the recipient device 130. For example, in some instances, the transfer service computing system 140 includes one or more APIs that securely communicate with the provider computing system 110 and allow for various functionality performed by the transfer service computing system 140 to be embedded within the provider client application provided by the provider computing system 110 to the merchant device 120 and/or the recipient device 130.

In some embodiments, the transfer service computing system 140 may, for example, include one or more servers, each with one or more processing circuits including one or more processors configured to execute instructions stored in one or more memory devices, send and receive data stored in the one or more memory devices, and perform other operations to implement the methods and functionalities described herein. As shown in FIG. 1, the transfer service computing system 140 may include one or more I/O device(s) 142, a network interface circuit 144, a transfer processing circuit 146, a transfer service account database 148, and other circuits in the same or similar manner to the other components of computing environment 100.

The one or more I/O devices 142 are configured to receive inputs from and display information to a user. While the term “I/O” is used, it should be understood that the I/O devices 142 may be input-only devices, output-only devices, and/or a combination of input and output devices.

In some instances, the network interface circuit 144 includes, for example, program logic that connects the transfer service computing system 140 to the network 101. For example, in some instances, the program logic interfaces with one or more transceivers (e.g., Bluetooth, Wi-Fi, or any other suitable communication transceivers) to enable connection with the network 101. The network interface circuit 144 facilitates secure communications between the provider computing system 110, the merchant device 120, the recipient device 130, and the transfer service computing system 140. The network interface circuit 144 also facilitates communication with other entities, such as other banks or financial institutions, settlement systems, and so on. In some instances, the network interface circuit 144 may include user interface program logic configured to generate and present application pages, web pages, and/or various other data to users (e.g., merchants, recipients) accessing the transfer service computing system 140 over the network 101.

The transfer processing circuit 146 is configured to enable real-time or near real-time transfers between registered users of the transfer service. In some instances, various providers (e.g., the provider associated with the provider computing system 110) may opt into the transfer service to allow their customers (e.g., the merchant associated with the merchant device 120 and/or the recipient associated with the recipient device 130) to register their accounts for the transfer service. In some instances, opting into the transfer service may include the corresponding providers accepting various terms and conditions for allowing the transfer service to enable transfers between accounts held by different providers.

Once the providers have opted into the transfer service, the providers'customers are able to register for and utilize the transfer service provided by the transfer service computing system 140. For example, in some instances, during a registration process, the transfer service computing system 140 is configured to receive one or more desired transfer service identifiers (e.g., a Zelle® identifier), such as a phone number, an e-mail address, an alphanumeric tag, another token, etc., to be associated with a customer (e.g., the merchant associated with the merchant device 120 and/or the recipient associated with the recipient device 130) registering for the transfer service. During the registration process, the transfer service computing system 140 is further configured to receive various account information (e.g., a bank routing number, a bank account number) and identifying information (e.g., a name, a phone number, an e-mail address, a physical address) associated with the customer to be linked to the corresponding received desired transfer service identifier(s) for registering the customer with the transfer service.

Accordingly, the transfer service computing system 140 is configured to receive a registration request from the merchant device 120 and/or the recipient device 130 to register a particular account of the user (e.g., an account held by the provider stored within the provider account database 116) for the transfer service. Upon receiving the registration request, the transfer service computing system 140 is configured to store the transfer service identifier, the account information, and the identifying information for the user within the transfer service account database 148 and to link the transfer service identifier to the account information and the identifying information within the transfer service account database 148 to register the user with the transfer service.

Once the transfer service identifier, the account information, and the identifying information for the user have been stored and linked within the transfer service account database 148, the transfer processing circuit 146 is configured to, upon receipt of a transfer request (e.g., received from the provider computing system 110, the merchant device 120, or the recipient device 130), query the transfer service account database 148 to retrieve the corresponding account information and identifying information associated with recipient and sender transfer service identifiers included in the requested transfer. Although the recipient is described herein as receiving an offer from a merchant, it should be appreciated that in some embodiments, the merchant may be a recipient of funds/resources from the recipient of the offer. For example, in some embodiments, the recipient of the offer may transfer funds/resources to the merchant to redeem the offer. In the example, the recipient of the offer may be a sender of the funds/resources, and the merchant may be a recipient of the funds/resources. Once the corresponding account information is successfully retrieved by the transfer processing circuit 146, the transfer processing circuit 146 is configured to initiate a transfer (e.g., of funds) from an account associated with a sender (e.g., a recipient of an offer) to an account associated with the recipient (e.g., the merchant).

In some instances, users are allowed to register for the transfer service using accounts held at multiple different provider institutions. In these instances, the users register for the transfer service with each provider institution using a different transfer service identifier (e.g., a Zelle® identifier) that is then linked or otherwise associated with that particular account and provider institution within the provider account database 116. Accordingly, in some instances, a single user may be registered for multiple transfer service identifiers associated with multiple different provider institutions.

To allow for the transfer service computing system 140 to identify the various transfer service identifiers associated with each user, in some instances, the transfer service computing system 140 assigns a universal identifier to each user when they register for the transfer service. For example, in some instances, in addition to the registration process discussed above, the transfer service computing system 140 may separately generate a universal identifier that is associated with the user. In some instances, the universal identifier may be linked to the user's name, address, date of birth, and social security number.

Accordingly, if the user registers for a new transfer service identifier with a new provider institution, if the user's name, address, date of birth, and social security number (which are exemplary items as certain instances may use more user attributes, different user attributes, or less user attributes) match those associated with an existing universal identifier, the transfer service computing system 140 is able to identify that it is the same user registering for the new transfer service identifier. In some instances, the transfer service computing system 140 further stores a list of each transfer service identifier associated with each user and associates that list with the user's universal identifier. As such, in some instances, the transfer service computing system 140 is configured to transmit a list of the user's various transfer service identifiers and associated account information to the user (e.g., to the merchant device 120, to the recipient device 130).

In some instances, the transfer service computing system 140 is configured to allow for merchants to transmit localized offers to a subset of users within a defined geofence. That is, in some instances, as will be described below, merchants may utilize the transfer service to send an offer relating to a good/service provided by the merchant to a group of users that may be located proximate to the merchant. The users (e.g., recipients) may receive the offer via the transfer service and, in some embodiments, may be allowed to redeem the offer via the transfer service. For example, if the offer includes a discount on a subscription service, the recipient may transfer the funds corresponding to the discounted amount due for the subscription service to the merchant.

As discussed above, the transfer service account database 148 stores transfer service identifiers, corresponding account information, and corresponding identifying information for various transfer service accounts that are maintained by the transfer service on behalf of its users. The transfer service account database 148 is configured to be used by the transfer processing circuit 146 to enable the real-time or near real-time transfers discussed above.

With an example structure of the computing environment 100 being described above, example processes performable by the computing environment 100 (or components/systems thereof) will be described below. It should be appreciated that the following processes are provided as examples and are in no way meant to be limiting. Additionally, various method steps discussed herein may be performed in a different order or, in some instances, completely omitted. These variations have been contemplated and are within the scope of the present disclosure.

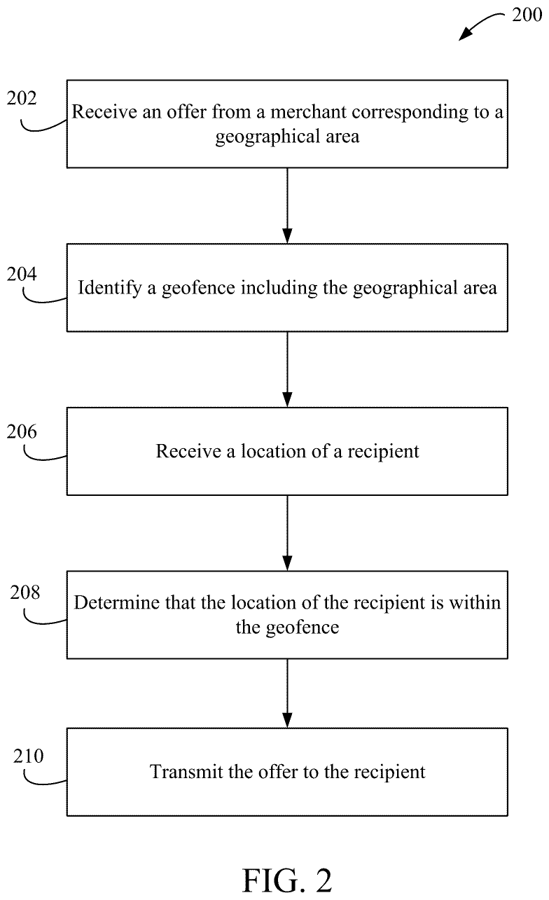

Referring to FIG. 2, a flow diagram of a method 200 for transmitting an offer based on a geofence from a merchant (e.g., associated with the merchant device 120) to a recipient (e.g., associated with the recipient device 130) is shown, according to an example embodiment. As used herein, the “merchant”is meant to refer to a provider of a good/service to a consumer. Similarly, the “recipient” is mean to refer to a consumer of the goods/services provided by the merchant. Various operations of the method 200 may be conducted by the computing environment 100 (e.g., the provider computing system 110, the merchant device 120, the recipient device 130, and the transfer service computing system 140).

As shown, the method 200 begins with receiving an offer from a merchant corresponding to a geographical area, at step 202. The merchant may generate the offer (e.g., as described below with reference to step 302 of method 300) via the provider computing system 110 (e.g., via the provider client application on the merchant device 120). For example, the merchant may have a customer account at the provider institution associated with the provider computing system 110. The transfer service computing system 140 may then receive the generated offer from the provider computing system 110 (e.g., via the network interface circuits 114/144. The offer may include a discount or other consumer benefit related to a good/service provided by the merchant. The offer may further relate to a geographical area in which the good/service is being provided by the merchant. For example, if the merchant is a pizza restaurant located within a specific zip code, the offer may include a discount on a meal at the pizza restaurant and may therefore be related to the specific zip code in which the pizza restaurant is located.

After receiving the offer at step 202, the method 200 may continue with identifying a geofence including the geographical area, at step 204. In some embodiments, the merchant may specify the geofence while generating the offer. Continuing with the example of the merchant being a pizza restaurant, the merchant may define the geofence as being a 10-mile radius surrounding the location (e.g., a physical address) of the pizza restaurant. Alternatively or additionally, the provider computing system 110 and/or the transfer service computing system 140 may automatically define the geofence including the geographical area. For example, rather than the merchant defining the geofence as being a 10-mile radius surrounding a location of the merchant, the provider computing system 110 and/or the transfer service computing system 140 may automatically define the geofence as being a 10-mile radius surrounding the location of the merchant.

The method 200 may further include receiving a location of a recipient, at step 206. In various embodiments, the location of the recipient may be identified using at least one of a global positioning system (GPS) of a user device (e.g., the location sensor 134 of the recipient device 130), account information associated with the recipient (e.g., stored in the provider account database 116 and/or the transfer service account database 148), or a real-time transaction associated with the recipient. Where the location of the recipient is identified using the location sensor 134 of the recipient device 130, the location may be a real-time physical location of the recipient. The location of the recipient may be identified from a physical address associated with an account of the recipient held by at least one of the provider institution and/or the transfer service. In such embodiments, the transfer service may be configured to identify the location of the recipient by accessing the account information, including the physical address of the recipient, from the provider account database 116 and/or the transfer service account database 148.

The account information may also include a transaction history associated with the recipient. For example, the transaction history may include a plurality of transactions previously performed by the recipient (e.g., between the recipient and a merchant, between the recipient and a user via the transfer service, and so on). In some embodiments, transaction previously performed by the recipient may include a location associated therewith. The location may include an address associated with a merchant included in the transaction, the location of the recipient at the time of the transaction, etc. Therefore, the transaction history associated with the recipient may indicate that the recipient performs transactions within a geographical area, and the geographical area may be identified as the location of the recipient based on the transaction history. In a similar way, the location of the recipient may be identified from a real-time transaction. That is, the provider computing system 110 and/or the transfer service computing system 140 may receive an indication that a user (e.g., a recipient associated with the recipient device 130) has performed a transaction at a particular location. For example, the particular location may include an address of a merchant included in the real-time transaction, a location of the recipient device 130 (e.g., determined by the location sensor 134) at the time of the real-time transaction, etc. Therefore, the real-time transaction associated with the recipient may reveal a recipient's location.

Based on the location of the recipient received at step 206, the method 200 may continue by determining that the location of the recipient is within the geofence, at step 208. That is, the provider computing system 110 and/or the transfer service computing system 140 may compare the location of the recipient received at step 206 to the geofence identified at step 204 and determine whether the location of the recipient received at step 206 is within the geofence identified at step 204.

As shown in FIG. 2, the method 200 may include transmitting the offer to the recipient, at step 210. In some embodiments, the offer may be transmitted to the recipient device 130 via at least one of the provider computing system 110, the transfer service computing system 140, or a third-party computing system (e.g., a provider computing system associated with a financial institution that is not the provider associated with the provider computing system 110 described herein). For example, the third-party computing system may be associated with a financial institution that also uses the transfer service. In some embodiments, the offer may be transmitted via the one or more client applications 138 (e.g., the provider client application, the transfer service client application). For instance, the recipient may receive the offer as a notification from the one or more client applications 138 on the recipient device 130. The offer may be displayed via a graphical user interface (GUI) on the recipient device 130 (e.g., GUI 700, as described below with reference to FIG. 7).

In some embodiment, the offer may be transmitted to the recipient based on behavioral trends associated with the recipient. That is, the transfer service computing system 140 may be configured to receive a behavioral report associated with the recipient. In some embodiments, the behavioral report may be stored in at least one of the provider account database 116 or the transfer service account database 148. The behavioral report may include, for instance, information such as at least one of a transaction frequency, a transaction location, an entity category associated with a transaction (e.g., groceries, clothing, entertainment, gas, travel, etc.), a service included in a transaction, or a good included in a transaction. Therefore, based on the information included in the behavioral report, the transfer service computing system 140 may determine that the merchant from which the offer is received at step 202 relates to the information included in the behavioral report and may be of interest to the recipient. Based on the determination that the merchant relates to the information included in the behavioral report, the transfer service computing system 140 may transmit the offer to the recipient. For example, if the offer received at step 202 relates to a discount at a pizza restaurant, the transfer service computing system 140 may be configured to transmit the offer to a subset of recipients from the recipients identified within the geofence at step 208 whose behavioral report includes one or more previous transactions at a pizza restaurant and/or otherwise relating to pizza. In some embodiments, an artificial intelligence (AI) model may be used to analyze the data included in the behavioral report and determine the recipient(s) that may have a particular interest in the offer.

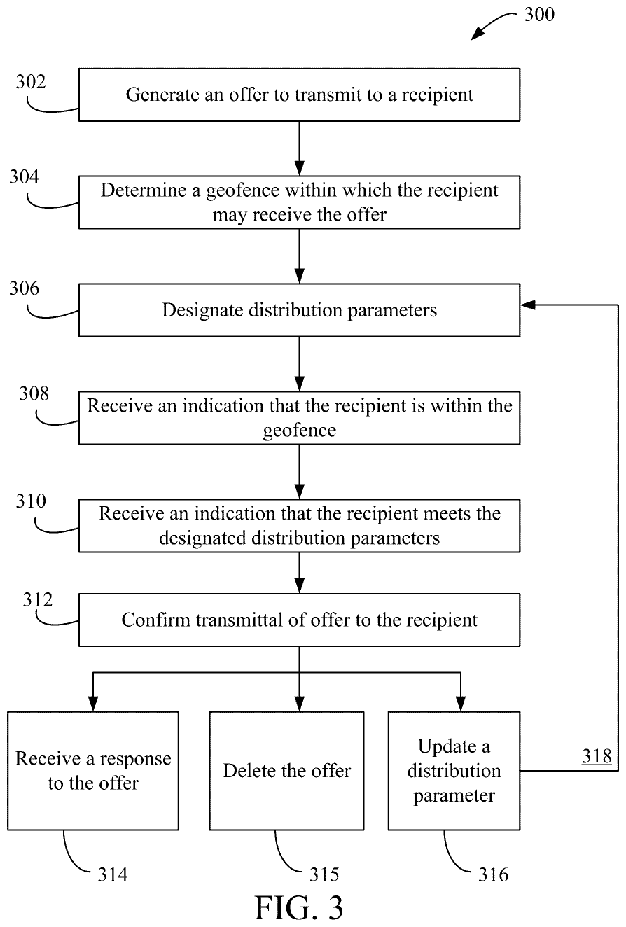

Referring to FIG. 3, a flow diagram of a method 300 for generating and managing an offer (e.g., by a merchant associated with the merchant device 120) to transmit to a recipient (e.g., associated with the recipient device 130) based on a geofence is shown, according to an example embodiment. Various operations of the method 300 may be conducted by the computing environment 100 (e.g., the provider computing system 110, the merchant device 120, the recipient device 130, and the transfer service computing system 140).

As shown, the method 300 begins with generating an offer to transmit to a recipient, at step 302. In some embodiments, the merchant may generate the offer via the client applications 128 on the merchant device 120 (e.g., the provider client application and/or the transfer service client application). The merchant may, in some instances, generate a one-time offer to transmit to recipients, or may generate a recurring offer to transmit to recipients. For example, the one-time offer may include a one-time discount on a good and/or service provided by the merchant. The recurring offer, on the other hand, may include offering a discount on a good and/or service provided by the merchant according to a particular frequency/pattern (e.g., weekly, monthly, semi-annually, annually, etc.). For example, the recurring offer may include a 25% discount on a select good/service automatically generated on the first day of every month.

After generating the offer at step 302, the method 300 may continue with determining a geofence within which the recipient may receive the offer, at step 304. In some embodiments, as described above with reference to step 204 of method 200, the merchant may define the geofence while generating the offer. Alternatively or additionally, the provider computing system 110 and/or the transfer service computing system 140 may automatically define the geofence including the geographical area. For example, the provider computing system 110 and/or the transfer service computing system 140 may automatically define the geofence as being a 10-mile radius surrounding the location of the merchant.

The method 300 may further include designating distribution parameters, at step 306. The distribution parameters may determine when and to whom the offer generated at step 302 is transmitted. In some embodiments, the distribution parameters may include at least one of a time of distribution, a target demographic for distribution, or a boundary of the geofence. The time of distribution refers to a time when the offer is to be transmitted to a recipient. For example, the merchant may designate a particular date (e.g., Thursday, Aug. 8, 2024) and/or time (e.g., midnight) when the offer is to be transmitted to a recipient. In some instances where the offer generated at step 302 includes a recurring offer, the time of distribution may include a time when each of the recurring offers is to be transmitted to a recipient (e.g., at midnight on the first day of each month).

The target demographic for distribution refers to one or more demographic characteristics of a recipient to whom the offer may be transmitted. For example, if the merchant relates to a childcare service, the target demographic for distribution of the offer may include parents of young children. As another example, if the merchant relates to a distributor of agricultural equipment, the target demographic for distribution may include recipients who work in the agricultural industry. As yet another example, if the merchant relates to hurricane-proof building supplies, the target demographic for distribution may include recipients who live in an area prone to experiencing hurricanes (e.g., Florida). The boundary of the geofence refers to a geographical area which defines the geofence. For example, as described above, the boundary of the geofence may include a 10-mile radius surrounding a location of the merchant. In some embodiments, the boundary of the geofence may be drawn manually on a map by the merchant. Alternatively or additionally, the merchant, the provider institution, and/or the transfer service may define the boundary of the geofence by selecting one or more municipalities (e.g., a town, a village, a city, etc.), counties, zip codes, etc., to include within the geofence.

Based on the geofence determined at step 304, the method 300 may include receiving an indication that the recipient is within the geofence, at step 308. As described above, the location of the recipient may be identified using at least one of a global positioning system (GPS) of a user device (e.g., the location sensor 134 of the recipient device 130), account information associated with the recipient (e.g., stored in the provider account database 116 and/or the transfer service account database 148), or a real-time transaction associated with the recipient. In some embodiments, the merchant may receive a notification (e.g., via the client applications 128 on the merchant device 120) with the indication that the recipient is within the geofence. FIG. 5, for example, illustrates an exemplary depiction of an indication on the merchant device 120 that a recipient has been identified with the geofence.

Based on the distribution parameters designated at step 306, the method 300 may include receiving an indication that the recipient meets the designated distribution parameters, at step 310. That is, after identifying the recipient is within the geofence at step 308, the method 300 may further include determining whether the recipient within the geofence meets additional distribution parameters associated with the offer. For instance, where the distribution parameters designate a target demographic for distribution, the transfer service computing system 140 may determine that the recipient belongs to the target demographic for distribution based on account information associated with the recipient (e.g., stored in the transfer service account database 148). Therefore, the transmittal of the offer to the recipient (e.g., step 210 of method 200) may be based on the determination that the recipient belongs to the target demographic for distribution. Continuing with the example above of the merchant relating to childcare services, and where the target demographic for distribution has been identified as parents of young children, step 310 may include determining whether the recipient identified within the geofence is a parent of a young child. Alternatively or additionally, where the distribution parameters designate the time of distribution, the transfer service computing system 140 may determine that a current time corresponds to the designated time of distribution. Therefore, the transmittal of the offer to the recipient (e.g., step 210 of method 200) may be based on the determination that the current time corresponds to the time of distribution. In some embodiments, the provider computing system 110 and/or the transfer service computing system 140 may be used to determine whether the recipient meets the designated distribution parameters (e.g., based on information stored in the provider account database 116 and/or the transfer service account database 148). Alternatively or additionally, the merchant may interact with a selectable element on a user interface of the merchant device 120 (e.g., option 525 on the GUI 500, as described below with reference to FIG. 5) to manually filter (e.g., choose) the recipients from the recipients identified within the geofence at step 308.

As shown in FIG. 3, the method 300 may continue with confirming a transmittal of the offer to the recipient, at step 312. For example, the merchant may confirm the transmittal of the offer to the recipient using a selectable element on a user interface of the merchant device 120 (e.g., option 520 on the GUI 500, as described below with reference to FIG. 5). In some embodiments, after confirming the transmittal of the offer to the recipient, the transfer service computing system 140 may be configured to transmit the offer to the recipient, as described above with reference to step 210 of method 200.

After the offer is transmitted to the recipient, the method 300 may include at least one of receiving a response to the offer at step 314, deleting the offer at step 315, or updating a distribution parameter at step 316. In some embodiments, receiving the response to the offer at step 314 may include at least one of receiving a transfer of funds/resources from the recipient of the offer via the transfer service computing system 140 (e.g., via the transfer service client application on the merchant device 120), receiving an indication that the recipient of the offer has declined the offer (e.g., step 406 of method 400), receiving an indication that the recipient of the offer has enrolled in a service included in the offer (e.g., step 408 of method 400), receiving an indication that the recipient of the offer has redeemed the offer online (e.g., step 410 of method 400), or receiving an indication that the recipient of the offer has redeemed the offer at an in-person location (e.g., step 412 of method 400, as described below).

In some embodiments, deleting the offer at step 315 may include deleting the offer that has been transmitted to the recipient. For example, the merchant may delete the offer after an expiration of a time period. Alternatively or additionally, the provider institution and/or the transfer service may automatically delete the offer after the expiration of the time period.

Updating the distribution parameter at step 316 may include updating any of the distribution parameters described above with reference to step 306. For example, the merchant may choose to widen the target demographic for distribution, expedite the time of distribution, and/or expand the boundary of the geofence. In some embodiments, where the method 300 includes updating the distribution parameter at step 316, the method 300 may further include an iterative process at step 318 in which the method 300 returns to step 306 (e.g., designating distribution parameters) and performs the remaining steps of method 300 based on the updated distribution parameter from step 316. In some embodiments, the merchant may also generate additional offers using the method 300 described herein.

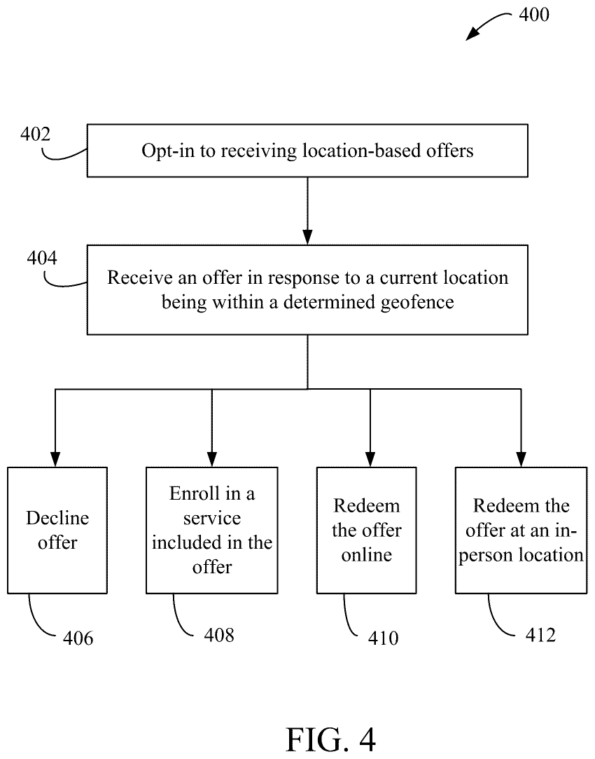

Referring to FIG. 4, a flow diagram of a method 400 for a recipient (e.g., associated with the recipient device 130) receiving an offer from a merchant (e.g., associated with the merchant device 120) based on a geofence is shown, according to an example embodiment. Various operations of the method 400 may be conducted by the computing environment 100 (e.g., the provider computing system 110, the merchant device 120, the recipient device 130, and the transfer service computing system 140).

As shown, the method 400 begins with a recipient opting-in to receiving location-based offers, at step 402. The recipient may opt-in to receiving the located-based offers via the one or more client applications 138 on the recipient device 130 (e.g., the provider client application and/or the transfer service client application). Alternatively or additionally, the recipient may opt-in to receiving the location-based offers when creating an account with the provider institution and/or the transfer service. In some embodiments, opting-in to receiving location-based offers may include providing an authorization to the transfer service computing system 140 to transmit the offers to the recipient (e.g., via the one or more client applications 138).

In some embodiments, providing the authorization further includes providing a consent for the transfer service computing system 140 to access a location of the recipient. That is, the consent for the transfer service computing system 140 to access the location of the recipient may include consent to receive GPS data from the location sensor 134 of the recipient device 130, consent to receive a physical address included in account information associated with the recipient (e.g., from the provider institution stored in the provider account database 116), consent to receive a transaction history associated with the recipient (e.g., from the provider institution stored in the provider account database 116), and so on.

After opting-in to receiving location-based offers at step 402, the method 400 may continue with receiving an offer in response to a current location of the recipient being within a determined geofence, at step 404. For example, the offer received at step 404 may include the offer transmitted by the transfer service computing system 140 at step 210 of method 200. In some embodiments, the recipient may receive the offer via the recipient device 130 (e.g., as a push notification from the client applications 138, a text message, and email message, etc.). FIG. 7, for instance, depicts an example of an offer received by the recipient device 130 (e.g., via GUI 700).

After receiving the offer at step 404, the method 400 may further include responding to the offer. In some embodiments, responding to the offer may include at least one of declining the offer at step 406, enrolling in a service included in the offer at step 408, redeeming the offer online at step 410, or redeeming the offer at an in-person location at step 412. The recipient may decline the offer, for instance, via a selectable element on a user interface of the recipient device 130 (e.g., option 715 on the GUI 700, as described below with reference to FIG. 7). Enrolling in the service included in the offer at step 408 may include signing-up or otherwise registering for a service included in the offer. For example, the merchant may relate to an exercise facility and the offer may include a discount on a membership at the exercise facility. In this example, creating a membership at the exercise facility may be the response to the offer.

The response to the offer may further include at least one of redeeming the offer online at step 410 or redeeming the offer at an in-person location at step 412. For example, if the merchant operates an ecommerce platform/online store, the recipient of the offer may purchase a good/service associated with the offer online via the ecommerce platform/online store at step 410. In this example, the recipient of the offer may enter a code associated with the offer at checkout of the good/service. In some embodiments, redeeming the offer online at step 410 may include completing a transfer of funds from the recipient to the merchant via the transfer service computing system 140, as described herein. In various instances where the merchant operates a brick-and-mortar establishment (e.g., a restaurant, a store, a salon, etc.), the recipient may respond to the offer by redeeming the offer at an in-person location (e.g., the brick-and-mortar establishment) at step 412. For example, redeeming the offer at the in-person location may include presenting a display of the offer (e.g., the display of the incoming offer 705 on the GUI 700, as described below) to an employee at the in-person location.

Referring to FIG. 5, a GUI 500 for generating and transmitting an offer based on a geofence is shown. The GUI 500 may be configured to be displayed to a merchant associated with the merchant device 120 via the client application 128 during a client application session (e.g., while the merchant associated with the merchant device 120 has successfully launched and accessed/logged in to the client application 128). The GUI 500 may include an option to view all pending offers 505, a display of a selected offer 510, an indication of a number of recipients within a geofence 515, an option to transmit the selected offer to the number of recipients 520, and an option to filter the number of recipients 525.

The option to view all pending offers 505 may refer to a selectable element configured to present, to the merchant via a user interface on the merchant device 120, a list of offers that the merchant has generated. In some embodiments, the list of offers may include offers that have already been transmitted to a recipient and/or offers that the merchant has generated but that have not yet been transmitted to a recipient (e.g., if a designated time of distribution has not yet occurred).

The display of the selected offer 510 refers to a display of an offer from the list of offers that has been selected by the merchant. As shown in FIG. 5, the display of the selected offer 510 may include the terms included in the offer (e.g., a 50% discount on Mondays). The display of the selected offer 510 may also include an option to edit distribution parameters associated with the selected offer. For example, interacting with the option to edit the distribution parameters on the GUI 500 may allow the merchant to perform step 316 of method 300 (e.g., to update a distribution parameter associated with an offer). The GUI 500 in FIG. 5 also includes an option to delete the selected offer and an option to create a new offer.

The GUI 500 may include the indication of the number of recipients within a geofence 515. The geofence may be the geofence identified at step 204 of method 200/determined at step 304 of method 300. As shown in FIG. 5, for example, the indication of the number of recipients within a geofence 515 may recite “There are 210 users in your geofence”. The indication of the number of recipients within a geofence 515 may also include a selectable element (e.g., a map) configured to display a visualization of the geofence. For example, upon engaging with the map shown on the GUI 500 of FIG. 5, the merchant may receive a display of the geofence overlaid on a map of the geographical area including the geofence. In some embodiments, the merchant may update the boundary of the geofence from the map of the geographical area by selecting additional areas to include in the geofence, selecting areas to remove from the geofence, and/or otherwise adjusting the boundary of the geofence on the map of the geographical area. In some embodiments, the map of the geographical area may also designate where each of the recipients identified as being within the geofence are located. In this way, the merchant may choose to remove geographical areas from the geofence where few/no recipients are identified.

As shown in FIG. 5, the GUI 500 may include the option to transmit the selected offer to the number of recipients 520 and the option to filter the number of recipients 525. The option to transmit the selected offer to the number of recipients 520 may allow the merchant to confirm the transmittal of the offer to a recipient, as described above with reference to step 312 of method 300. Furthermore, after the merchant selects the option to transmit the selected offer to the number of recipients 520, the transfer service computing system 140 may be configured to transmit the offer to the number of recipients, as described above with reference to step 210 of method 200.

Alternatively, the merchant may choose to filter the number of recipients identified within the geofence before transmitting the offer by engaging with the option to filter the number of recipients 525. In some embodiments, after engaging with the option to filter the number of recipients 525, the merchant may receive a display including additional information (e.g., account information from the provider account database 116 and/or the transfer service account database 148) relating to each of the recipients identified within the geofence. For example, the merchant may choose to filter the recipients based on a transaction history included in the account information associated with each of the recipients. In this way, the merchant may filter the recipients of the offer such that the filtered recipients are those who have previously engaged in a transaction related to the offer. For example, if the offer relates to a discount at a pizza restaurant, the merchant may filter the number of recipients identified within the geofence such that the filtered recipients have previously performed transactions at a pizza restaurant (e.g., as shown by a respective transaction history).

Referring to FIG. 6, a GUI 600 for displaying analytics relating to a history of offers is shown. The GUI 600 may be configured to be displayed to a merchant associated with the merchant device 120 via the client application 128 during a client application session (e.g., while the merchant associated with the merchant device 120 has successfully launched and accessed/logged in to the client application 128). The GUI 600 may include an identification of an account associated with the merchant 605, a display of an analytics report 610, and an option to change a view of the analytics report 615.

As shown in FIG. 6, the identification of the account associated with the merchant 605 may include an account number. In some embodiments, the account number may refer to an account associated with the client application 138 being accessed. For example, if the GUI 600 is displayed to the merchant via the transfer service client application, the account number may refer to an account of the merchant at the transfer service. If the GUI 600 is displayed to the merchant via the provider client application, the account number may refer to an account of the merchant at the provider institution. The identification of the account associated with the merchant 605 may also include a name of the merchant (e.g., “Merchant A”).

In some embodiments, the transfer service computing system 140 may analyze a history of offers related to the merchant. In some embodiments, the transfer service computing system 140 may analyze the history of offers related to the merchant using information from the provider computing system 110 (e.g., stored in the provider account database 116). That is, the history of offers may include a number of offers provided over a timeframe (e.g., during the year 2023, during the month of January 2023, over a previous two-week period, etc.). The history of offers may also include a number of recipients reached by the provided offers over the timeframe. In some embodiments, the history of offers related to the merchant may further identify whether each of the offers provided over the timeframe were redeemed or declined (e.g., not redeemed). Information relating to the redeemed offers may also indicate whether the offers were redeemed in-person (e.g., as described with reference to step 412 of method 400) or online (e.g., as described with reference to step 410 of method 400).

Based on the analysis of the history of offers related to the merchant, the transfer service computing system 140 may generate a report (e.g., the display of the analytics report 610) for the identified merchant including the analysis of the history of offers. As shown in FIG. 6, the display of the analytics report 610 may include the number of recipients reached by the provided offers and the number of offers provided. In some embodiments, the number of recipients reached during the timeframe may be compared to the number of recipients reached during a different timeframe. For example, if analytics report is generated for the year 2023, the number of recipients reached during 2023 may be compared to the number of recipients reaching during the previous year, 2022. From the number of offers provided, the analytics report may further include the number of offers redeemed and the number of offers declined. The number of offers redeemed may further specify whether the offers were redeemed in-person or online. As shown in FIG. 6, the analytics report may also include a percentage of the provided offers that were redeemed. For example, if 3,209 offers were provided in 2023, and 2308 of the offers were redeemed, the analytics report may indicate that 72% of the provided offers during 2023 were redeemed. The analytics report may also compare the percentage for the timeframe associated with the analytics report displayed via the GUI 600 (e.g., 2023) to the percentage over a previous timeframe (e.g., 2022).

The option to change the view of the analytics report 615 allows the merchant to view an analytics report for a different timeframe. For example, if the analytics report for the year 2023 is shown on the GUI 600, the merchant may select the option to change the view of the analytics report 615 to receive a monthly analytics report. As another example, from the option to change the view of the analytics report 615, the merchant may receive an analytics report over a different year (e.g., 2022).

Referring to FIG. 7, a GUI 700 for displayed an offer received based on a geofence is shown. The GUI 700 may be configured to be displayed to a recipient associated with the recipient device 130 via the client application 138 during a client application session (e.g., while the recipient associated with the recipient device 130 has successfully launched and accessed/logged in to the client application 138). The GUI 700 may include a display of an incoming offer 705, a display of a location where the incoming offer may be redeemed 710, an option to accept (e.g., redeem) the offer 712, an option to decline the offer 715, an option to view all current offers that the recipient has pending 720, and an option to manage account preferences 725.

In some embodiments, the display of the incoming offer 705 is a display of the offer transmitted at step 210 of method 200. As shown in FIG. 7, the display of the incoming offer 705 may include a merchant from which the offer is being received (e.g., 123 Coffee Roasters) and terms of the offer (e.g., a 50% discount on select coffees from 4PM-7PM). In some embodiments, the display of the incoming offer 705 may also include an expiration of the offer (e.g., 1/11/24).

With the display of the incoming offer 705, the GUI 700 may display the location where the incoming offer may be redeemed 710. For example, if the merchant from which the offer is received (e.g., 123 Coffee Roasters) operates a brick-and-mortar location, the location where the incoming offer may be redeemed may be an address of the brick-and-mortar location. In some embodiments, the address of the brick-and-mortar location may include hyperlinked text. The hyperlinked text may display, when clicked on/otherwise selected by the recipient, directions to the brick-and-mortar location. Similarly, in some embodiments, the GUI 700 may include a selectable element (e.g., a map icon) configured to display, when clicked on/otherwise selected by the recipient, the directions to the brick-and-mortar location. Alternatively or additionally, if the merchant from which the offer is received operates an ecommerce platform/online store, the display of the location where the incoming offer may be redeemed 710 may include a link (e.g., a hyperlinked text) to the ecommerce platform/online store.

As referenced above, the GUI 700 may include one or more options to respond to the offer. As shown in FIG. 7, the one or more options may include the option to accept the offer 712 and the option to decline the offer 715. Therefore, the option to accept the offer 712 may allow the recipient to perform at least one of steps 408, 410, or 412 of method 400. For example, if the incoming offer may be redeemed at a brick-and-mortar location associated with the merchant, the option to accept the offer 712 may allow the recipient to redeem the offer at the in-person location (e.g., step 412). As another example, if the incoming offer may be redeemed via an ecommerce platform/online store associated with the merchant, the option to accept the offer 712 may allow the recipient to redeem the offer online (e.g., step 410). As yet another example, if the incoming offer relates to a service in which the recipient may enroll, the option to accept the offer 712 may allow the recipient to enroll in the service included in the offer (e.g., step 408). Similarly, the option to decline the offer 715 may allow the recipient of the offer to perform step 406 of method 400 (e.g., decline offer).

The GUI 700 may present to the recipient the option to view all current offers 720. In some embodiments, the option to view all current offers 720 may present a list of offers that the recipient has received from a merchant. The list of offers may include offers that have not yet expired and offers that the recipient has not yet redeemed nor declined. Thus, the list of offers may display a list of active offers that the recipient may yet redeem.

As shown in FIG. 7, the GUI 700 may also present the option to manage account preferences 725. In some embodiments, the option to manage account preferences 725 may allow the recipient to update one or more settings related to the offers being received during method 400. For example, the account preferences may include whether the recipient chooses to receive location-based offers, a geographical area in which the recipient chooses to receive location-based offers, one or more merchants from which the recipient chooses to receive location-based offers, an entity category (e.g., industry) from which the recipient chooses to receive location-based offers, a frequency with which the recipient chooses to receive location-based offers, and so on.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f) unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud-based server). To that end, a “circuit” as described herein may include components that are distributed across one or more locations.

An exemplary system for implementing the overall system or portions of the embodiments might include general-purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general-purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, a joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

1. A transfer service computing system comprising:
a processing circuit having one or more processors coupled to one or more memory devices storing instructions thereon that, when executed by the one or more processors, cause the processing circuit to perform operations comprising:
receiving, from a provider computing system or from a user interface displayed on a user device of a recipient via the transfer service computing system, an offer relating to a merchant and corresponding to a geographical area associated with the merchant;
identifying a geofence including the geographical area associated with the merchant;
receiving a real-time location of the user device using a global positioning system of the user device;
determining that the real-time location of the user device is within the geofence;
transmitting, to the user device, the offer responsive to the determination that the location of the user device is within the geofence, wherein the offer is transmitted to the user device only after the user device has entered the geofence;
causing the offer to be presented to the user via the user interface displayed on the user device; and
transmitting a transaction request to the provider computing system or to a third-party computing system based on receiving an acceptance of the offer from the user device via the user interface.

2. The transfer service computing system of claim 1, wherein transmitting the offer to the user device comprises transmitting via at least one of the transfer service computing system, the provider computing system, or the third-party computing system.

3. The transfer service computing system of claim 1, wherein the operations further comprise:
generating and displaying an offer creation user interface on a merchant device of the merchant, wherein the offer creation user interface enables customization of a distribution parameter associated with the offer, deleting the offer, or generating additional offers.

4. The transfer service computing system of claim 3, wherein the distribution parameter comprises at least one of a time of distribution, a target demographic for distribution, or a boundary of the geofence.

5. The transfer service computing system of claim 4, wherein the operations further comprise:
determining, based on account information associated with the recipient, that the recipient belongs to the target demographic for distribution; and
transmitting, to the user device, the offer based on the determination that the recipient belongs to the target demographic for distribution.

6. The transfer service computing system of claim 4, wherein the operations further comprise:
determining that a current time corresponds to the time of distribution; and
transmitting, to the user device, the offer based on the determination that the current time corresponds to the time of distribution.

7. The transfer service computing system of claim 1, wherein the operations further comprise:
generating, on a user interface of the user device, a plurality of user interface options to interact with the offer; and
receiving, via the user interface of the user device, a user input corresponding to the acceptance of the offer.

8. The transfer service computing system of claim 1, wherein the operations further comprise:
analyzing a history of offers related to the merchant;
generating a report for display on the merchant device, the report comprising the analysis of the history of offers, wherein the report further comprises a number of provided offers and a number of redeemed offers.

9. The transfer service computing system of claim 1, wherein the operations further comprise receiving, from the user device, an authorization to transmit the offer, wherein the authorization further comprises a consent to receive location data indicative of the location of the user device.

10. The transfer service computing system of claim 1, wherein the operations further comprise:
transmitting, to the user device, the offer based on a comparison of a characteristic of the merchant with a characteristic of the recipient, wherein the characteristic of the recipient is based on a transaction history of the recipient or a demographic.

11. The transfer service computing system of claim 1, wherein the location of the user device is identified using at least one of a global positioning system (GPS), account information associated with the recipient, or a real-time transaction associated with the recipient.

12. A method comprising:
receiving, by a transfer service computing system and from a provider computing system or from a user interface displayed on a user device of a recipient via the transfer service computing system, an offer relating to a merchant and corresponding to a geographical area associated with the merchant;
identifying, by the transfer service computing system, a geofence including the geographical area associated with the merchant;
receiving, by the transfer service computing system, a real-time location of the user device using a global positioning system of the user device;
determining, by the transfer service computing system, that the real-time location of the user device is within the geofence;
transmitting, by the transfer service computing system and to the user device, the offer responsive to the determination that the location of the user device is within the geofence, wherein the offer is transmitted to the user device only after the user device has entered the geofence;
causing, by the transfer service computing system, the offer to be presented to the user via the user interface displayed on the user device; and
transmitting a transaction request to the provider computing system or to a third-party computing system based on receiving an acceptance of the offer from the user device via the user interface.

13. The method of claim 12, further comprising generating and displaying an offer creation user interface on a merchant device of the merchant, wherein the offer creation user interface enables customization of a distribution parameter associated with the offer, deleting the offer, or generating additional offers.

14. The method of claim 13, wherein the distribution parameter comprises at least one of a time of distribution, a target demographic for distribution, or a boundary of the geofence.

15. The method of claim 14, further comprising:
determining, by the transfer service computing system and based on account information associated with the recipient, that the recipient belongs to the target demographic for distribution;
determining, by the transfer service computing system, that a current time corresponds to the time of distribution; and
transmitting, by the transfer service computing system and to the user device, the offer based on at least one of the determination that the recipient belongs to the target demographic for distribution or the determination that the current time corresponds to the time of distribution.

16. The method of claim 12, further comprising:
analyzing, by the transfer service computing system, a history of offers related to the merchant; and
generating, by the transfer service computing system, a report for display on the merchant device, the report comprising the analysis of the history of offers, wherein the report further comprises a number of provided offers and a number of redeemed offers.

17. The method of claim 12, further comprising receiving, by the transfer service computing system from the user device, an authorization to transmit the offer, wherein the authorization further comprises a consent to receive location data indicative of the location of the user device.

18. The method of claim 12, further comprising:
transmitting, to the user device, the offer based on a comparison of a characteristic of the merchant with a characteristic of the recipient, wherein the characteristic of the recipient is based on a transaction history of the recipient or a demographic.

19. The method of claim 12, wherein the location of the user device is identified using at least one of a global positioning system (GPS), account information associated with the recipient, or a real-time transaction associated with the recipient.

20. A non-transitory computer-readable medium storing instructions that, when executed by one or more processors of a processing circuit, cause the processing circuit to:
receive, from a provider computing system or from a user interface displayed on a user device of a recipient via a transfer service computing system, an offer relating to a merchant and corresponding to a geographical area associated with the merchant;
identify a geofence including the geographical area associated with the merchant;
receive a real-time location of the user device using a global positioning system of the user device;
determine that the real-time location of the user device is within the geofence;
transmit, to the user device, the offer responsive to the determination that the location of the user device is within the geofence, wherein the offer is transmitted to the user device only after the user device has entered the geofence;
cause the offer to be presented to the user via the user interface displayed on the user device; and
transmit a transaction request to the provider computing system or to a third-party computing system based on receiving an acceptance of the offer from the user device via the user interface.
